(19) United States
(12) Patent Application Publication
(10) Pub. No.: US 2022/0207109 A1
(43) Pub. Date: Jun. 30, 2022

(54) CONVOLUTION METHOD, ELECTRONIC DEVICE, AND COMPUTER-READABLE STORAGE MEDIUM

(71) Applicant: GUANGDONG OPPO MOBILE TELECOMMUNICATIONS CORP., LTD., Dongguan (CN)

(72) Inventors: Ming CHEN, Palo Alto, CA (US); Chiuman HO, Palo Alto, CA (US); Zibo MENG, Palo Alto, CA (US)

(21) Appl. No.: 17/697,911

(22) Filed: Mar. 17, 2022

Related U.S. Application Data
(63) Continuation of application No. PCT/CN2020/118550, filed on Sep. 28, 2020.
(60) Provisional application No. 62/930,887, filed on Nov. 5, 2019.

(51) Int. Cl. G06F 17/16; G06F 17/15

(52) U.S. Cl. CPC G06F 17/16; G06F 17/15

(57) ABSTRACT

A convolution method, an electronic device and a non-transitory computer-readable storage medium are provided. The method includes that: multiple resultant matrices respectively corresponding to multiple 1×1 convolution kernel elements in a filter are added to different sub-regions of a first output matrix, to obtain an accumulating feature of the first output matrix, and a second output matrix is extracted from the first output matrix with the accumulating feature. A size of the second output matrix is less than a size of the first output matrix.

### CROSS-REFERENCE TO RELATED APPLICATIONS

The present application is a continuation of International Application No. PCT/CN2020/118550, filed Sep. 28, 2020, which claims priority to U.S. Provisional Application No. 62/930,887, filed Nov. 5, 2019, the entire disclosures of which are incorporated herein by reference.

### TECHNICAL FIELD

The disclosure relates to the field of convolution technologies, and more particularly to a convolution method, an electronic device and a non-transitory computer-readable storage medium.

### BACKGROUND

Convolutional Neural Networks (CNNs) have been the heart of spectacular advances in deep learning. Computer vision tasks, such as image/video classification, have significantly benefited from the emerging deep learning techniques. As one of the major components of CNNs, convolution is involved in both training and inference, which is the most computationally intensive operation in CNNs, requiring a lot of memory storage and computational power. For instance, in the most popular CNN network on an embedded system, i.e. the MobileNets, 90% of computation time is spent on the pointwise convolution operations.

### SUMMARY

The embodiments of the disclosure provide a convolution method, an electronic device, and a non-transitory computer-readable storage medium.

According to an aspect, the disclosure provides a convolution method, which may include the operations as follows. Multiple resultant matrices respectively corresponding to multiple 1×1 convolution kernel elements in a filter are added to different sub-regions of a first output matrix, to obtain an accumulating feature of the first output matrix. A second output matrix is extracted from the first output matrix with the accumulating feature. A size of the second output matrix is less than a size of the first output matrix.

According to another aspect, the disclosure provides an electronic device, which may include a memory and a processor. The memory stores a computer program. The processor is adapted to call and execute the computer program in the memory to execute operations of a convolution method. The convolution method includes operations as follows. Multiple resultant matrices respectively corresponding to multiple 1×1 convolution kernel elements in a filter are added to different sub-regions of a first output matrix, to obtain an accumulating feature of the first output matrix. A subset from the first output matrix having the accumulating feature is extracted as a second output matrix.

According to yet another aspect, the disclosure provides a non-transitory computer-readable storage medium storing one or more computer programs. The computer programs may cause a processor to execute operations of a convolution method. The convolution method includes operations as follows. Based on multiple 1×1 convolution kernel elements and an input matrix, multiple resultant matrices respectively corresponding to the multiple 1×1 convolution kernel element. The multiple resultant matrices are added to different sub-regions of a first output matrix, to obtain an accumulating feature of the first output matrix. A second output matrix is extracted from the first output matrix with the accumulating feature, and a size of the second output matrix is less than a size of the first output matrix.

### BRIEF DESCRIPTION OF THE DRAWINGS

The accompanying drawings described herein which are incorporated into and form a part of the disclosure are provided for the better understanding of the disclosure, and exemplary embodiments of the disclosure and description thereof serve to illustrate the disclosure but are not to be construed as improper limitations to the disclosure. In the accompanying drawings:

FIG. 1 is a schematic diagram of a KnToRow method.

FIG. 2 is a schematic diagram of a Hole Punching Accumulating KnToRow method.

FIG. 3 is a schematic flowchart of a convolution method according to an embodiment of the disclosure.

FIG. 4 is a schematic diagram of a convolution method according to an embodiment of the disclosure.

FIG. 5 is a schematic structure diagram of a convolution device according to an embodiment of the disclosure.

FIG. 6 is a schematic structure diagram of an electronic device according to an embodiment of the disclosure.

FIG. 7 is a schematic structure diagram of a chip according to an embodiment of the disclosure.

### DETAILED DESCRIPTION

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

In order to facilitate the understanding of the technical solutions of the disclosure, terms and technologies related to the embodiments of the disclosure are described below.

### 1) Key Terms

GEMM: GEneral Matrix Multiplication

KnToRow (Kernel-To-Row): Rearrange kernel blocks into rows

Pointwise convolution: convolution with a kernel size of 1×1

HWCMK:
H refers the number of pixels in vertical dimension (Height);
W refers the number of pixels in horizontal dimension (Width);
C refers to the image channel;
M refers to the number of filters/kernels;
K refers to the kernel size.

### 2) KnToRow Method and its Variants

A convolution between an image tensor of shape C×H×W and a filter tensor of shape M×C×K×K will generate an output of shape M×H×W.

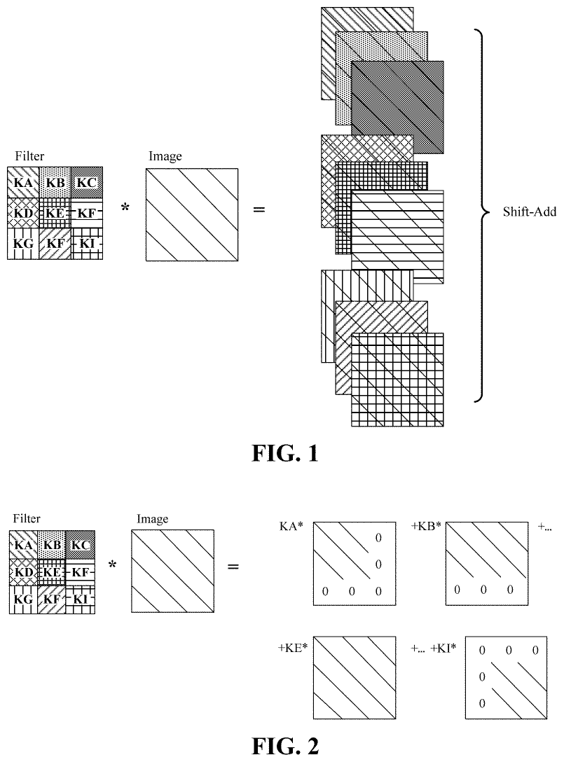

The Kernel-To-Row (KnToRow) method treats the K×K convolution as a sum of the K² separate 1×1 convolutions. The 1×1 convolution is equal to General Matrix Multiplication between a filter and an image, and lots of highly optimized basic linear algebra libraries (BLAS) may be used. To store the parallel 1×1 convolutions results, K² temporary matrices in the size of M×[H×W] are required. These resultant matrices need to be shifted, horizontally and/or vertically by one or more pixels, before being added to the final output. As illustrated in FIG. 1, blocks with different patterns represent the resultant matrices from the 1×1 convolutions that are shifted horizontally and/or vertically before being added to the final output. Some values of the shifted matrices fall outside the boundaries of the final output and need to be neglected when the sum of 1×1 convolutions is computed. Extra space of size (K²−1)×M×H×W is needed. Two variants, Accumulating KnToRow and Hole Punching Accumulating KnToRow, follow the same idea of KnToRow.

In the Accumulating KnToRow method, the 1×1 convolutions are realized by the GEMM call from the optimized BLAS libraries: C=α×(A*B)+β×C, with α=1, β=0. A is a kernel element from {KA, KB, . . . KI} in the filter, B is the image and C is the temporary buffer to store the 1×1 convolution result. A submatrix that lies within the boundary, after the resultant buffer is shifted, is then added to the final output. To reduce the memory cost, unlike the parallel computing for all the 1×1 convolutions in the KnToRow method, the Accumulating KnToRow method processes the kernel elements sequentially. Therefore, an extra space of size M×H×W is needed.

In the Hole Punching Accumulating KnToRow method, the accumulating feature of GEMM is used by C=α×(A*B)+β×C, with α=1, β=1. A is a kernel element from {KA, KB, . . . KI} in the filter, B is the image, C is the reserved output space of size (M+2δ)×H×W with

$$δ = ⌈ \frac{K}{2 H} ⌉ ,$$

and the final output is a subset of size M×H×W in it. The 1×1 convolution and shift-add sum up are realized together by one GEMM call. However, due to the accumulating feature of GEMM, some of the incorrect pairs of edge image pixels and kernel values are added into the final output. To correct these erroneous pixels, an intermediate operation between each GEMM call is proposed—parts of the edge image pixels are being zeroed before every accumulating GEMM call (illustrated in FIG. 2). An extra space of size 2δ×H×W with

$$δ = ⌈ \frac{K}{2 H} ⌉$$

is needed.

The previous methods are mainly subjected to two inefficient operations: 1) to extract a submatrix every time before being added to the final output in the Accumulating KnToRow method; 2) to recover and modify the image matrix before every accumulating GEMM call.

The proposed convolution method in the disclosure avoids these two inefficient operations at the cost of small memory space and achieves considerable acceleration. To reduce the computational cost, the disclosure has developed and implemented a fast low-memory convolution method on both CPUs and GPUs. The disclosure also reveals that the optimal performance for the KnToRow method and all its variants (including the proposed convolution method in the disclosure) is achieved when the number of filters is not larger than the input channels, which is capable of being used as a guidance for the CNN architecture design.

The technical solutions of the embodiments of the disclosure are described in detail below.

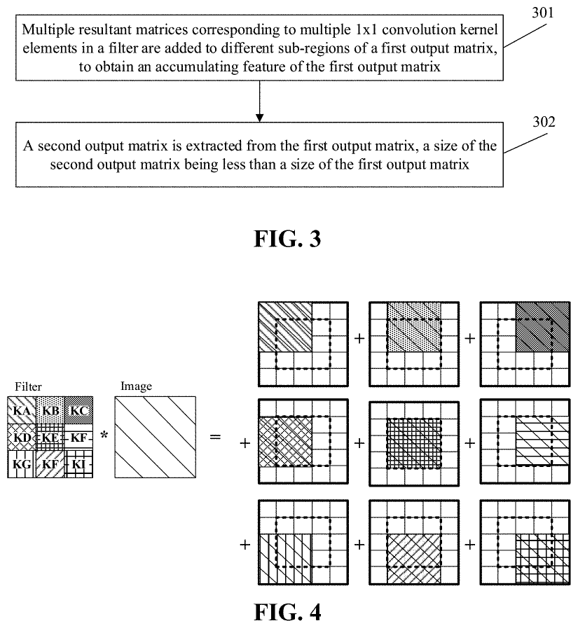

FIG. 3 illustrates a schematic flowchart of a convolution method according to an embodiment of the disclosure. As illustrated in FIG. 3, the convolution method may include the following operations.

In 301, multiple resultant matrices corresponding to multiple 1×1 convolution kernel elements in a filter are added to different sub-regions of a first output matrix, to obtain an accumulating feature of the first output matrix.

In the embodiment of the disclosure, the filter may be called a convolution kernel. The filter is represented by a tensor, and an element in the tensor represents a convolution kernel element. For example, the tensor representing the filter includes a set of matrices {KA, KB, . . . KI}, and each matrix in the set represents a 1×1 convolution kernel element.

In the embodiment of the disclosure, the filter has a size of K×K, and the filter includes K² 1×1 convolution kernel elements.

Based on this, the filter with a size of K×K may be converted into K² 1×1 convolution kernel elements, then K² resultant matrices respectively corresponding to the K² 1×1 convolution kernel elements may be determined and the K² resultant matrices are added to different sub-regions of the first output matrix.

In the embodiment of the disclosure, the accumulating feature of the first output matrix is obtained by the following manner.

According to a first 1×1 convolution kernel element in the filter and an input matrix, such as an image, a first resultant matrix corresponding to the first 1×1 convolution kernel element is determined and the first resultant matrix is added to a respective first sub-region of the first output matrix.

Traversal on multiple 1×1 convolution kernel elements in the filter is performed, each of the multiple resultant matrices corresponding to a respective one of the multiple 1×1 convolution kernel elements in the filter is added to a respective different sub-region of the first output matrix, and the accumulating feature of the first output matrix is obtained. In other words, after adding the first resultant matrix to the first sub-region of the first output matrix, traversal on the remaining 1×1 convolution kernel elements are performed.

The first 1×1 convolution kernel element mentioned above may be any one of the K² 1×1 convolution kernel elements.

It should be noted that the image may be any image. There are no limits made to the source and type of the image in the disclosure.

In a specific implementation, the first resultant matrix is added to the first sub-region of the first output matrix according to the formula: α×(A*B)+β×C, where α=1, β=1, A represents the first 1×1 convolution kernel element, B represents the image, and C represents the first output matrix.

In the above implementation, the first resultant matrix corresponding to the first 1×1 convolution kernel element is A*B. The resultant matrices respectively corresponding to the remaining 1×1 convolution kernel elements can be acquired in a similar manner as the first resultant matrix.

In the above implementation, the size of the first output matrix is

$$M \times [ ( H + 2 {δ}_{H} ) \times ( W + 2 {δ}_{W} ) ] \cdot {δ}_{H} = ⌈ \frac{K}{2 H} ⌉ , {δ}_{W} = ⌈ \frac{K}{2 W} ⌉ ,$$

M represents the number of filters, K represents a size of the filter, H represents the number of pixels of the image in vertical dimension, and W represents the number of pixels of the image in horizontal dimension.

In 302, a second output matrix is extracted from the first output matrix, a size of the second output matrix being less than a size of the first output matrix.

In the embodiment of the disclosure, the size of the second output matrix is M×[H×W], and the second output matrix is a subset of the first output matrix. The second output matrix is the convolution operation result corresponding to the filter. In other words, the second output matrix is the output of the convolution of the filter and the image.

The technical solution of the embodiments in the disclosure has the advantages of high processing speed and less consumption of processing resources (such as memory). Instead of reserving a contiguous memory of size

$$( M + 2 δ ) \times H \times W with δ = ⌈ \frac{K}{2 H} ⌉ ,$$

the disclosure reserves a larger memory space (denoted as the first output matrix or Large_output) of size

$$M \times [ ( H + 2 {δ}_{H} ) \times ( W + 2 {δ}_{W} ) ] with {δ}_{H} = ⌈ \frac{K}{2 H} ⌉ , {δ}_{W} = ⌈ \frac{K}{2 W} ⌉ .$$

The final output (i.e., the second output matrix) is a subset of size M×H×W in the Large_output. As illustrated in FIG. 4, let M=1, the large block with thick solid lines represents the Large_output and the center dashed block represents the final output. Each resultant matrix is added to different sub-region of the Large_output. After all the resultant matrices are summed up, the final output is extracted from the Large_output.

In a specific implementation, for each of the multiple resultant matrices corresponding to the respective one of the multiple 1×1 convolution kernel elements, the respective sub-region of the first output matrix is determined based on a relative location of respective one of the multiple 1×1 convolution kernel elements in the filter. For example, the first sub-region of the first output matrix is determined based on a relative location of the first 1×1 convolution kernel element in the filter, and the first resultant matrix is added to a first sub-region of the first output matrix.

As illustrated in FIG. 4, the 1×1 convolution kernel element in the filter and the sub-region corresponding to the 1×1 convolution kernel element are illustrated with the same fill pattern, such as cross-hatching. Taking the 1×1 convolution kernel element located in the upper left corner of the filter, which is denoted as KA, as an example, the resultant matrix corresponding to KA is added to the corresponding sub-region in the upper left corner of the first output matrix, and the corresponding sub-region is illustrated with the same fill pattern as KA. In other words, the same fill pattern indicates the 1×1 convolution kernel element in the filter and the sub-region in the first output matrix corresponding to the 1×1 convolution kernel element.

It should be noted that, FIG. 4 is a schematic diagram to illustrate the correspondence between the 1×1 convolution kernel elements in the filter and the sub-regions in the first output matrix. When performing traversal on each of the multiple 1×1 convolution kernel elements in the filter, the respective resultant matrix corresponding to the 1×1 convolution kernel element is added to a respective sub-region of the first output matrix on which the resultant matrices respectively corresponding to previous 1×1 convolution kernel elements have been added (if any). For example, when performing traversal in the order KA, KB, . . . , KI, the resultant matrix corresponding to KB is added to the first output matrix which has added the resultant matrix corresponding to KA.

In the embodiment of the disclosure, a target memory space is reserved according to the size of the first output matrix and the target memory space is used to store the first output matrix. Further, the target memory space may be a contiguous memory.

The size of the target memory space is M×[(H+2δ_{H})×(W+2δ_{w})], and the first output matrix is stored in the target memory space.

The proposed convolution method in the disclosure can utilize the efficiency of accumulating GEMM call without too much submatrix extractions or input image modification. Contrary to the Accumulating KnToRow method which extracting the submatrix K² times, the proposed convolution method only extracts the submatrix once. Also, all the incorrect pairs of edge image pixels and kernel values are stored outside the final output block and are being discarded at the final submatrix extraction thus it won't affect the final output.

Further, on the CPU side, is that the disclosure uses Eigen library for GEMM call and submatrix extraction. Multithreading for parallel computing each kernel element contribution is aided through Eigen internal non-blocking ThreadPool module. The intrinsic lazy evaluation feature from Eigen also contributes to the optimized performance. On the GPU side, the disclosure uses cuBLAS library for GEMM call and submatrix extraction—cuBLAS library is carefully hand-coded by NVIDIA and includes auto-tuning mechanism to maximize GPU performance.

In the following benchmark test, the disclosure illustrates, though the proposed convolution method costs an extra space of size

$$M \times [ ( H + 2 {δ}_{H} ) \times ( W + - 2 {δ}_{W} ) ] - M \times [ H \times W ] = 2 M \times ( H \times {δ}_{W} + W \times {δ}_{H} + 2 {δ}_{H} {δ}_{W} ) , with {δ}_{H} = ⌈ \frac{K}{2 H} ⌉ , {δ}_{W} = ⌈ \frac{K}{2 W} ⌉$$

which is around 2 times of that of the Hole Punching Accumulating KnToRow method, it provides considerable acceleration.

To benchmark the performance of the proposed convolution method in the disclosure, the disclosure implemented it as a static library that can be called directly as an executable file or as a customized operation within TensorFlow. The proposed convolution method has been tested both on the CPU and GPU platforms. On the CPU side, the disclosure implemented optimized Im2Col, KnToRow, Accumulating KnToRow, and Hole Punching Accumulating KnToRow methods for comparison. The obtained result indicates that the proposed fast low-memory convolution can provide an average of 6×, 2× and 1.6× times acceleration compared to the Im2Col, Accumulating KnToRow, and Hole Punching Accumulating KnToRow methods respectively.

Further, one interesting phenomenon is observed during the benchmark testing—the optimal performance of the proposed convolution is related to the ratio of filter number over channel number (M/C) for the KnToRow method and all its variants (including the proposed convolution method in the disclosure). Take the 3×3 proposed convolution as an example, keeping the value of H, W, K, M×C fixed, the smaller the M/C is, the better performance the proposed convolution method can achieve—M/C=0.5 can provide 40% runtime reduction compared to that of M/C=1, and 70% runtime reduction compared to that of M/C=2. This observation holds for both CPU and GPU testings, and can be used to guide the model architecture design.

The proposed convolution method in the disclosure is outperformed than most of the prevailing convolution methods yet cost little memory overheads. Further, the disclosure also reveals that the optimal performance for the KnToRow method and all its variants (including the proposed convolution method) achieved when the number of filters is no larger than the input channels. This observation can be used to guide the model architecture design.

According to the above technical solutions of the disclosure, a convolution operation of the filter is converted into convolution operations on multiple 1×1 convolution kernel elements in the filter, and multiple resultant matrices corresponding to multiple 1×1 convolution kernel elements are respectively added to different sub-regions of a first output matrix in an accumulating manner, i.e., so as to obtain an accumulating feature of the first output matrix. Further, a second output matrix is extracted from the first output matrix, and the second output matrix is the result of the convolution operation on the filter. Therefore, the technical solution of the disclosure not only reduces memory overheads, but also significantly improves the processing efficiency of the convolution operation.

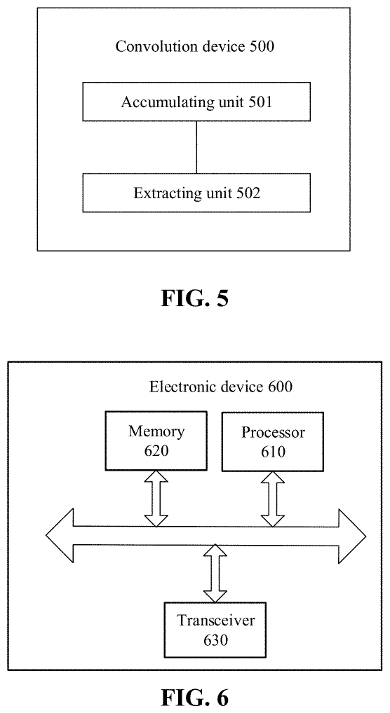

The embodiments of the disclosure also provide a convolution device, to implement the above-mentioned convolution method. As illustrated in FIG. 5, the convolution device may include an accumulating unit 501 and an extracting unit 502.

The accumulating unit 501 is adapted to add multiple resultant matrices corresponding to multiple 1×1 convolution kernel elements in a filter to different sub-regions of a first output matrix, to obtain an accumulating feature of the first output matrix.

The extracting unit 502 is adapted to extract a second output matrix from the first output matrix. The size of the second output matrix is less than the size of the first output matrix.

In at least one implementation, the accumulating unit 501 may further be adapted to determine, according to a first 1×1 convolution kernel element in the filter and an image, a first resultant matrix corresponding to the first 1×1 convolution kernel element and add the first resultant matrix to a first sub-region of the first output matrix; and perform traversal on multiple 1×1 convolution kernel elements in the filter, add each of the multiple resultant matrices corresponding to a respective one of the multiple 1×1 convolution kernel elements in the filter to a respective sub-region of the first output matrix, and obtain the accumulating feature of the first output matrix.

In at least one implementation, the accumulating unit 501 may further be adapted to add the first resultant matrix to the first sub-region of the first output matrix according to the formula: C=α×(A*B)+β×C. α=1, ß=1, A represents the first 1×1 convolution kernel element, B represents the image, and C represents the first output matrix.

In at least one implementation, the first resultant matrix corresponding to the first 1×1 convolution kernel element may be A*B.

In at least one implementation, the size of the first output matrix may be

$$M \times [ ( H + 2 {δ}_{H} ) \times ( W + 2 {δ}_{W} ) ] \cdot {δ}_{H} = ⌈ \frac{K}{2 H} ⌉ , {δ}_{W} = ⌈ \frac{K}{2 W} ⌉ ,$$

M represents the number of filters, K represents a size of the filter, H represents the number of pixels of the image in vertical dimension, and W represents the number of pixels of the image in horizontal dimension.

In at least one implementation, the size of the second output matrix may be M×[H×W], and the second output matrix may be a subset of the first output matrix.

In at least one implementation, the convolution device may include a storage unit. The storage unit is adapted to reserve a target memory space according to the size of the first output matrix. The target memory space may be used to store the first output matrix.

In at least one implementation, the target memory space is a contiguous memory.

In at least one implementation, the filter has a size of K×K, and the filter includes K² 1×1 convolution kernel elements.

In at least one implementation, the accumulating unit 501 may be adapted to convert the filter with a size of K×K into K² 1×1 convolution kernel elements, determine K² resultant matrices corresponding to respective 1×1 convolution kernel elements, and add K² resultant matrices to different sub-regions of the first output matrix.

It is to be understood that in the embodiments of the disclosure, the description on the convolution device may be understood with reference to the above related description on the convolution method.

FIG. 6 is a schematic structure diagram of an electronic device according to an embodiment of the disclosure. The electronic device may be any device with a computing processing capability such as a terminal or a server. As illustrated in FIG. 6, the electronic device may include a processor 610. The processor 610 may call and execute the computer programs in a memory to execute the method in the embodiments of the disclosure.

In at least one embodiment, as illustrated in FIG. 6, the communication device 600 may further include a memory 620. The processor 610 may call and execute the computer programs in the memory 620 to execute the method in the embodiments of the disclosure.

In at least one embodiment, the method may include operations as follows. Multiple resultant matrices respectively corresponding to multiple 1×1 convolution kernel elements in a filter are added to different sub-regions of a first output matrix, to obtain an accumulating feature of the first output matrix. A subset from the first output matrix having the accumulating feature is extracted as a second output matrix. For a specific implementation process, reference is made to the method embodiments. Details are not described here again.

The memory 620 may be a separate device from the processor 610, and may also be integrated into the processor 610.

In at least one embodiment, as illustrated in FIG. 6, the electronic device 600 may further include a transceiver 630. The processor 610 may control the transceiver 630 to communicate with another device. Specifically, the processor 610 may control the transceiver 630 to send information or data to another device, or receive information or data from another device.

The transceiver 630 may include a transmitter and a receiver. The transceiver 630 may further include one or more antennas.

In at least one embodiment, the electronic device 600 may specifically be a network device in the embodiments of the disclosure. The electronic device 600 may implement a corresponding process implemented by the network device in each method embodiment of the disclosure, which will not be elaborated herein for brief description.

In at least one embodiment, the communication device 600 may specifically be a terminal/mobile terminal in the embodiments of the disclosure. The communication device 600 may implement a corresponding process implemented by the terminal/mobile terminal in each method embodiment of the disclosure, which will not be elaborated herein for brief description.

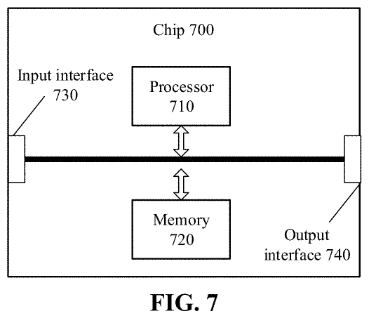

FIG. 7 is a schematic structure diagram of a chip according to an embodiment of the disclosure. As illustrated in FIG. 7, the chip 700 includes a processor 710. The processor 710 may call and execute the computer programs in a memory to execute the method in the embodiments of the disclosure.

In at least one embodiment, as illustrated in FIG. 7, the chip 700 may further include a memory 720. The processor 710 may call and execute the computer programs in the memory 720 to execute the method in the embodiments of the disclosure.

The memory 720 may be a separate device from the processor 710, and may also be integrated into the processor 710.

In at least one embodiment, the chip 700 may further include an input interface 730. The processor 710 may control the input interface 730 to communicate with another device or chip. Specifically, the processor 710 may control the input interface 730 to obtain information or data from another device or chip.

In at least one embodiment, the chip 700 may further include an output interface 740. The processor 710 may control the output interface 740 to communicate with another device or chip. Specifically, the processor 710 may control the output interface 740 to send information or data to another device or chip.

In at least one embodiment, the chip may be applied to the network device in the embodiments of the disclosure. The chip may implement a corresponding process implemented by the network device in each method embodiment of the disclosure, which will not be elaborated herein for brief description.

In at least one embodiment, the chip may be applied to the terminal/mobile terminal in the embodiments of the disclosure. The chip may implement a corresponding process implemented by the terminal/mobile terminal in each method embodiment of the disclosure, which will not be elaborated herein for brief description.

It is to be understood that in the embodiments of the disclosure, the chip may also be referred to as a system level chip, a system chip, a chip system or a system-on-chip.

It is to be understood that in the embodiments of the disclosure, the processor may be an integrated circuit chip with a signal processing capability. In an implementation process, each operation of the method embodiments may be completed by an integrated logical circuit of hardware in the processor or an instruction in a software form. The processor may be a universal processor, a Digital Signal Processor (DSP), an Application Specific Integrated Circuit (ASIC), a Field Programmable Gate Array (FPGA) or another programmable logical device, discrete gate or transistor logical device and discrete hardware component. Each method, step and logical block diagram disclosed in the embodiments of the disclosure may be implemented or executed. The universal processor may be a microprocessor or the processor may also be any related processor and the like. The operations of the methods disclosed in combination with the embodiments of the disclosure may be directly embodied to be executed and completed by a hardware decoding processor, or executed and completed by a combination of hardware and software modules in the decoding processor. The software module may be located in a mature storage medium in the art, such as a Random Access Memory (RAM), a flash memory, a Read-Only Memory (ROM), a Programmable ROM (PROM), an Electrically Erasable PROM (EEPROM) or a register. The storage medium is located in the memory. The processor reads information in the memory, and completes the operations of the above methods in combination with hardware of the processor.

It may be understood that the memory in the embodiment of the disclosure may be a volatile memory or a non-volatile memory, or may include the volatile memory and the non-volatile memory. The non-volatile memory may be an ROM, a PROM, an Erasable PROM (EPROM), an EEPROM or a flash memory. The volatile memory may be an RAM and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory of the system and the method described in the disclosure is intended to include but not limited to memories of these and any other suitable type.

The embodiments of the disclosure also provide a computer-readable storage medium for storing one or more computer programs.

In at least one embodiment, the computer-readable storage medium may be applied in the network device of the embodiments of the disclosure. The computer programs may enable a processor to perform the corresponding process implemented by the network device in each method embodiment of the disclosure, which will not be elaborated herein for brief description.

The convolution method includes operations as follows. Based on multiple 1×1 convolution kernel elements and an input matrix, multiple resultant matrices respectively corresponding to the multiple 1×1 convolution kernel element. The multiple resultant matrices are added to different sub-regions of a first output matrix, to obtain an accumulating feature of the first output matrix. A second output matrix is extracted from the first output matrix with the accumulating feature, and a size of the second output matrix is less than a size of the first output matrix. For a specific implementation process, reference is made to the method embodiments. Details are not described here again

In at least one example, the computer-readable storage medium may be applied in the terminal/mobile terminal of the embodiments of the disclosure. The computer programs may enable a processor to perform the corresponding process implemented by the terminal/mobile terminal in each method embodiment of the disclosure, which will not be elaborated herein for brief description.

The embodiments of the disclosure also provide a computer program product. The computer program product includes one or more computer program instructions.

In at least one embodiment, the computer program product may be applied in the network device of the embodiments of the disclosure. The computer program instructions may enable a processor to perform the corresponding process implemented by the network device in each method embodiment of the disclosure, which will not be elaborated herein for brief description.

In at least one example, the computer program product may be applied in the terminal/mobile terminal of the embodiments of the disclosure. The computer program instructions may enable a processor to perform the corresponding process implemented by the terminal/mobile terminal in each method embodiment of the disclosure, which will not be elaborated herein for brief description.

The embodiments of the disclosure also provide a computer program.

In at least one embodiment, the computer program may be applied in the network device of the embodiments of the disclosure. The computer program, when executed by a processor, enables a processor to perform the corresponding process implemented by the network device in each method embodiment of the disclosure, which will not be elaborated herein for brief description.

In at least one example, the computer program may be applied in the terminal/mobile terminal of the embodiments of the disclosure. The computer program, when executed by a processor, enables a processor to perform the corresponding process implemented by the terminal/mobile terminal in each method embodiment of the disclosure, which will not be elaborated herein for brief description.

Those of ordinary skill in the art may realize that the units and algorithm operations of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working processes of the system, device and unit described above may refer to the corresponding processes in the method embodiment and will not be elaborated herein for convenient and brief description.

In some embodiments provided by the disclosure, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the operations of the method in each embodiment of the disclosure. The abovementioned storage medium includes: various media capable of storing program codes such as a U disk, a mobile hard disk, a ROM, a RAM, a magnetic disk or an optical disk.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A convolution method, comprising:
adding a plurality of resultant matrices respectively corresponding to a plurality of 1×1 convolution kernel elements in a filter to different sub-regions of a first output matrix, to obtain an accumulating feature of the first output matrix; and
extracting a second output matrix from the first output matrix with the accumulating feature, a size of the second output matrix being less than a size of the first output matrix.

2. The method according to claim 1, wherein the adding a plurality of resultant matrices respectively corresponding to a plurality of 1×1 convolution kernel elements in the filter to different sub-regions of the first output matrix, to obtain the accumulating feature of the first output matrix, comprises:
determining, based on an image and a first 1×1 convolution kernel element in the filter, a first resultant matrix corresponding to the first 1×1 convolution kernel element, and adding the first resultant matrix to a respective first sub-region of the first output matrix; and
performing traversal on remaining 1×1 convolution kernel elements of the plurality of 1×1 convolution kernel elements in the filter, thereby adding each of the plurality of resultant matrices corresponding to a respective one of the plurality of 1×1 convolution kernel elements in the filter to a respective different sub-region of the first output matrix, and obtaining the accumulating feature of the first output matrix.

3. The method according to claim 2, wherein the adding the first resultant matrix to a first sub-region of the first output matrix, comprises:
determining, based on a relative location of the first 1×1 convolution kernel element in the filter, the respective first sub-region of the first output matrix, and
adding the first resultant matrix to the respective first sub-region of the first output matrix.

4. The method according to claim 2, wherein the first resultant matrix is added to the first sub-region of the first output matrix based on the formula:
α×(A*B)+β×C
where α=1, β=1, A represents the first 1×1 convolution kernel element, B represents the image, C represents the first output matrix, and A*B represents the first resultant matrix corresponding to the first 1×1 convolution kernel element.

5. The method according to claim 2, wherein the size of the first output matrix is:
$$M \times [ ( H + 2 {δ}_{H} ) \times ( W + 2 {δ}_{W} ) ] where {δ}_{H} = ⌈ \frac{K}{2 H} ⌉ , {δ}_{W} = ⌈ \frac{K}{2 W} ⌉ ,$$
M represents a number of filters, the filter has a size of K×K, H represents a number of pixels of the image in vertical dimension, and W represents a number of pixels of the image in horizontal dimension.

6. The method according to claim 5, wherein the size of the second output matrix is M×[H×W], and the second output matrix is a subset of the first output matrix.

7. The method according to claim 1, further comprising:
reserving a target memory space based on the size of the first output matrix, the target memory space being used to store the first output matrix.

8. The method according to claim 7, wherein the target memory space is a contiguous memory.

9. The method according to claim 1, wherein the filter has a size of K×K, and the filter comprises K² 1×1 convolution kernel elements.

10. The method according to claim 1, wherein the adding the plurality of resultant matrices corresponding to the plurality of 1×1 convolution kernel elements in the filter to different sub-regions of the first output matrix, comprises:
converting the filter with a size of K×K into K² 1×1 convolution kernel elements;
determining K² resultant matrices respectively corresponding to the K² 1×1 convolution kernel elements; and
adding the K² resultant matrices to different sub-regions of the first output matrix.

11. An electronic device, comprising:
a memory storing a computer program; and
a processor, adapted to call and execute the computer program stored in the memory to execute operations of a convolution method comprising:
adding a plurality of resultant matrices respectively corresponding to a plurality of 1×1 convolution kernel elements in a filter to different sub-regions of a first output matrix, to obtain an accumulating feature of the first output matrix; and
extracting a subset from the first output matrix having the accumulating feature as a second output matrix.

12. The electronic device according to claim 11, wherein the adding a plurality of resultant matrices respectively corresponding to a plurality of 1×1 convolution kernel elements in a filter to different sub-regions of a first output matrix, to obtain an accumulating feature of the first output matrix, comprises:
for each of the plurality of 1×1 convolution kernel elements, acquiring a respective resultant matrix based on the 1×1 convolution kernel element and an input matrix, and adding the acquired resultant matrix to a respective sub-region of the first output matrix.

13. The electronic device according to claim 12, wherein the adding the acquired resultant matrix to a respective sub-region of the first output matrix, comprises:
determining, based on a relative location of each 1×1 convolution kernel element in the filter, a respective sub-region of the first output matrix; and
adding the resultant matrix to the respective sub-region of the first output matrix.

14. The electronic device according to claim 12, wherein the adding the resultant matrix to the respective sub-region of the first output matrix, comprises:
for each 1×1 convolution kernel element, adding the resultant matrix corresponding to the 1×1 convolution kernel element to the respective sub-region of the first output matrix according to the formula:
α×(A*B)+β×C
where α=1, β=1, A represents the 1×1 convolution kernel element, B represents the image, C represents the first output matrix, and A*B represents the resultant matrix corresponding to the 1×1 convolution kernel element.

15. The electronic device according to claim 12, wherein the size of the first output matrix is:
$$M \times [ ( H + 2 {δ}_{H} ) \times ( W + 2 {δ}_{W} ) ] where {δ}_{H} = ⌈ \frac{K}{2 H} ⌉ , {δ}_{W} = ⌈ \frac{K}{2 W} ⌉ ,$$
M represents a number of filters, the filter has a size of K×K, H represents a number of pixels of the image in vertical dimension, and W represents a number of pixels of the image in horizontal dimension.

16. The electronic device according to claim 15, wherein the size of the second output matrix is M×[H×W], and the second output matrix is a subset of the first output matrix.

17. The electronic device according to claim 11, further comprising:
reserving a target memory space based on a size of the first output matrix, the target memory space being used to store the first output matrix.

18. The electronic device according to claim 17, wherein the target memory space is a contiguous memory.

19. The electronic device according to claim 11, wherein the adding the plurality of resultant matrices corresponding to the plurality of 1×1 convolution kernel elements in the filter to different sub-regions of the first output matrix, comprises:
converting the filter with a size of K×K into K² 1×1 convolution kernel elements;
determining K² resultant matrices respectively corresponding to the K² 1×1 convolution kernel elements; and
adding the K² resultant matrices to different sub-regions of the first output matrix.

20. A non-transitory computer-readable storage medium having stored thereon a computer program that, when executed by a processor, causes the processor to implement operations of a convolution method, wherein the method comprises:
acquiring, based on a plurality of 1×1 convolution kernel elements and an input matrix, a plurality of resultant matrices respectively corresponding to the plurality of 1×1 convolution kernel elements;
adding the plurality of resultant matrices to different sub-regions of a first output matrix, to obtain an accumulating feature of the first output matrix; and
extracting a second output matrix from the first output matrix with the accumulating feature, a size of the second output matrix being less than a size of the first output matrix.
